(19) United States
(12) Patent Application Publication
(10) Pub. No.: US 2007/0182676 A1
(43) Pub. Date: Aug. 9, 2007

(54) Device for dynamic illumination

(76) Inventors: Andrei V. Sinyugin, Kharkov (UA); Yuriy A. Goncharenko, Artemievsk (UA); Yuriy I. Martinov, Kharkov (UA); Guennadi Soubbotine, Brooklyn, NY (US)

Correspondence Address: Ilya Zborovsky, 6 Schoolhouse Way, Dix Hills, NY, 11746, US

(21) Appl. No.: 10/625,455

(22) Filed: Jul. 24, 2003

(51) Int. Cl. G09G 3/32

(52) U.S. Cl. 345/82

(57) ABSTRACT

A device for dynamic illumination has groups of light sources, a power supply source, each of the groups of light sources is formed as a light-emitting module which includes light diodes selected from the group consisting of one light diode and several light diodes, electronic keys corresponding to the light diodes for power supply of the light diodes through ballast resistors, a processor containing control programs for controlling brightness and color of the light diodes in time with the use of a method of frequency-pulse modulation, for controlling the electronic keys and interaction of the processors including synchronization of their operation, the modules having inputs which are electrically connected with one another and outputs which are grounded, wherein the modules are united in three-dimensional structures.

### BACKGROUND OF THE INVENTION

The present invention relates to special areas of electrical technology and in particular to devices for light sources with control circuits and can be used with various advertising and demonstrating means with special effects, to provide visually observed three dimensional color images with unusual light effects, which create a special decorative effect in form of dynamically changed colorful decorative-art and advertising images, which are reproduced in volumes and on surfaces.

Devices of this type are known, for example switching devices of light-diode and lamp garland which have groups of light sources forming garlands of different colors, a pulse generator which switches the garlands and formed with a conventional circuit including transistors, trinistors and invertors for a smooth turning on and turning off of the garlands, with the implementation of the effect of “running wave” (magazine RADIO number 11, 1983, pages 52-54).

However, the light effect is redundant even with the presence of the so-called running wave. The modes of turning on and control of the light sources are static, they do not allow conversion to a new light effect, they operate in accordance with the algorithm of one constant memorizing device.

Also, a thyristor switching device is known for the lamps for illumination is disclosed in SU 1 775 878 and includes a pulse generator, a former of short pulses, a counter, a programming constant memorizing device, a multi-channel block of coordinating devices, four groups of thyristor, and a block of keys. Here the input of the former of short pulses is connected with a power source, and its output is connected with the information input of the block of keys, the constant memorizing device has additional groups of outputs connected with binary controlling inputs of the block of keys, the corresponding output of the latter is connected with the input of the channel of the block of coordinating devices so that the device can be simplified with the number of lamps for illumination exceeding 16, the reliability is increased, and the level of noise is reduced. Moreover, this technical solution expands functional possibilities of the device for obtaining new light effects, by three-stage change of the level of brightness of each lamp in accordance with any program.

As in the preceding device, the nature of the light effect is determined by the algorithm of the constant memorizing device, which leads to redundant light effects. The use of thyristor elements for commutation of current of the power source creates a radio noise and noise along the circuit. In addition the device practically does not allow conversion to new light effects, which narrows the possibilities of the use of the device for creating special effects.

A solution which is closest to the present invention is disclosed in RU2006191 and includes a light device for dynamic illumination which has groups of light sources, a programmed switch with a cycle controlling input, a cycle pulse generator and a control circuit, with a transmitter of ultrasound vibrations with a generator of ultrasound vibrations, a receiver of ultrasound vibrations and a circuit for processing of ultrasound vibrations.

The visual effect in this case can be increased by introduction of the connection between the light effects and rhythm of the sound frequency. However, in the absence of the sound frequency, the visual attractiveness of the light effect is reduced. Since the number of rhythms which are used in practice is not unlimited, the number of obtained dynamic effects in the proposed device is also limited. Therefore, the functional possibilities of the device are limited as well. Moreover, as in the preceding case, the device practically does not allow the possibility of conversion to new effects.

### SUMMARY OF THE INVENTION

Accordingly, it is an object of the present invention to provide a device for dynamic illumination which increases the variety of light effects, increases attractiveness due to increase of dynamic nature of the light effects, and expands functional possibilities of the device.

It is an object of the present invention to improve the device for dynamic illumination, in which due to forming each group of light sources as a light-emitting module including one or several light diodes, corresponding electronic keys which supply the light diodes through ballast resistors, a processor containing programs for controlling brightness and color of the light diodes in time with the use of the method of frequency-pulse modulation, for controlling electronic keys and interaction of the processors including synchronization of their work, with the inputs of the modules connected by an electric bus and the outputs which are grounded, the autonomous nature of each module is provided at one hand and the ability of interaction of the modules with one another is provided at the other end, and therefore the possibility is provided for creating the device without an exterior control with an unlimited number of modules, with the possibility of programming and changing the program of operation of each module, and therefore creation and change of the general program of operation and interaction of the modules.

This objective is achieved in that, in the known device for dynamic illumination which includes the groups of light sources and a power source, in accordance with the invention each group of the light sources is formed as a light-emitting module which includes one or several light diodes, electronic keys corresponding to them for supplying light diodes through ballast resistors, a processor which contains programs for controlling in time of brightness and color of the light diodes with the use of the method of frequency-pulse modulation, controlling the electronic keys and interaction of the processors including the synchronization of their operation, with the inputs of the modules united by an electrical bus and the outputs which are grounded, wherein the modules form three-dimensional structures.

In accordance with the present invention, the device can be connected to an external power source.

In accordance with the present invention, at least one module can contain an independent power source.

In accordance with a further feature of the present invention, the module can contains a sensor of signal, for example, a sensor of temperature, pressure, displacement, etc.

In accordance with the present invention the processor is formed so that it can carry out a sequence of actions which are necessary for turning on of the light sources and changing their intensity in accordance with the program performing N sub-programs of light effects in which after turning on of the power source zeroing of a variable of i-th number of the subprogram of light effects corresponding to a waiting mode is performed, and then starting from 1-st, i-th numbers of subprograms are given successively, fulfilling of the condition i<N is checked, and after a positive result of checking the performance of i-th subprogram of light effects is performed, after finishing the performance i-th subprogram of light effects, the number of the subprogram if increased by one, the checking and the fulfillment of i+1-th subprogram is repeated, and these actions are repeated until the whole sequence N of subprograms is completed, wherein with each subprogram Mi digital words are formed which provide L bytes of signals for controlling the light sources and correspond to the number of the light sources, outputs of signals for controlling light intensity and representing digital j-th sequence of 8-register numbers corresponding to the number of the light sources.

Devices for programmed switching of illuminating lamps is known, in which the program is selected manually or automatically in accordance with the closed cycle. This device is disclosed in the magazine “Radio, 1990, number 11, pages 65-66 and it allows to obtain some light effects, for example running lights, paired turning on of the lamps, etc. The device for creating various light effects, such as running lights with different number of simultaneously turned on lamps, changing movement of the light (reverse of the running-lights) and also obtaining effects alternating turning on of the lamps is disclosed in the publication, “Assistance to Radio Fans”, issue 104, 1989, pages 51-59, and SU 1,236,539. The main disadvantage of these devices as well as the previously mentioned devices, is the redundance and weak dynamic nature of the created light effects, static nature of circuits, which excludes fast conversion of the light effects.

Also, illumination assemblies are known which contain light modules with a plurality of light diodes, a power supply module and a processor for controlling electric current, which is supplied to the light-emitting diode, so that generation of a corresponding light is provided (U.S. Pat. Nos. 6,340,868; 6,211,626).

The proposed solution is significantly different from the known solutions since it allows to create new light effects fast by coordination of various combinations of light modules with individual programs. The programs are capable of interacting with one another so as to create various light effects. The modular principle of formation of spacial structures (linear or three dimensional) on various carriers, the presence of individual program in each module, the possibility of reprogramming of each module in the assembled device without its disassembly, increasing or reducing of the number of modules in the structure on each carrier, and the possibility to change the number of illuminated carriers, for example windows, or in other words fast adaptation without additional expenses for the circuitry, makes this device attractive when compared with similar non-modular devices, both in aesthetic and commercial aspect.

The proposed device is adaptable to devices for exterior advertising, as well as in the systems of monitoring, alarm, etc.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a diagram of a device for dynamic illumination composed of M groups of light-emitting modules which are grouped into a light-emitting line, wherein FIG. 1.1 is a diagram of interaction of the elements of the light-emitting line,

FIG. 1.2 is a view showing a diagram of a group of automatic elements on the line of the inventive device;

FIG. 1.3 is a view showing a diagram of the illumination of the groups of window glasses of the inventive device;

FIG. 1.4 is a view showing a diagram of a two-coordinate illumination of the inventive device;

FIG. 1.5 is a view showing a diagram of illumination of a curved line of the inventive device;

FIG. 2 is a view showing a diagram of a light-emitting module of the inventive device;

FIG. 3 is a view showing a diagram of a time cycle of the light-emitting module of the inventive device;

FIG. 4 is a view showing a diagram of power supply for each electronic key of the inventive device;

FIG. 5 is a view showing a diagram of a module with an internal power source of the inventive device;

FIG. 6 is a view showing a diagram of a device for dynamic illumination, contained M-groups of light-emitting modules and additional signal sensors, wherein:

FIG. 6.1 is a diagram of exchange of the signals,

FIG. 6.2 is a diagram of a simple linear topology;

FIG. 6.3 is a diagram of a branched topology without intersections;

FIG. 6.4 is an example of supply of information by a user,

FIG. 6.5 is a diagram of a three dimensional topology for location of modules with intersections;

FIG. 7 is a view graphically illustrating an algorithm of a program for controlling the operation of M groups of light sources of the inventive device.

### DESCRIPTION OF THE PREFERRED EMBODIMENTS

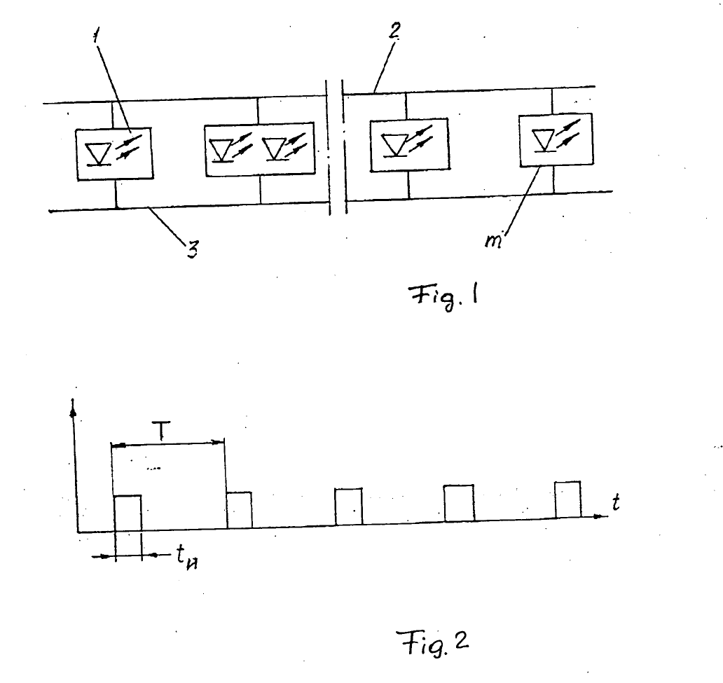

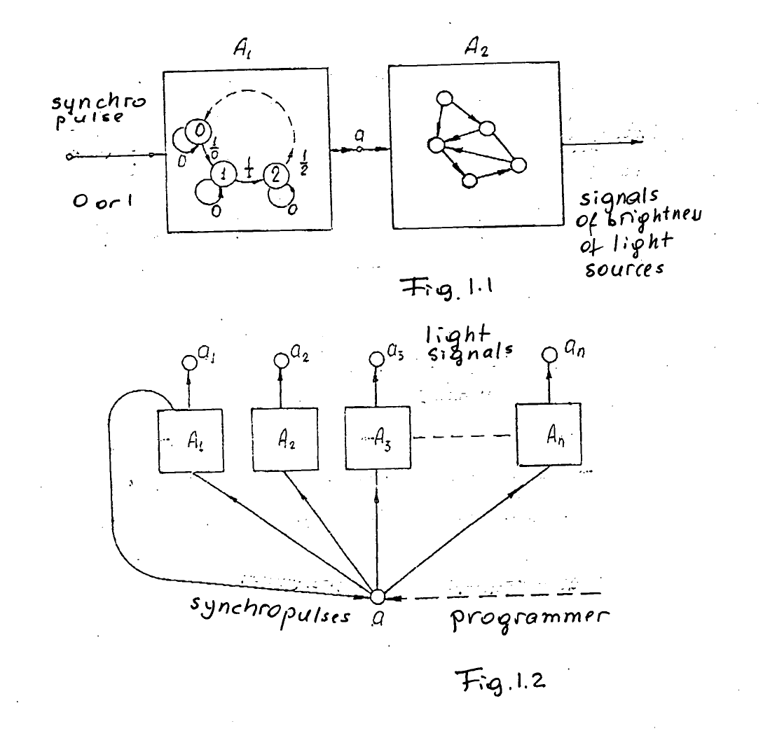

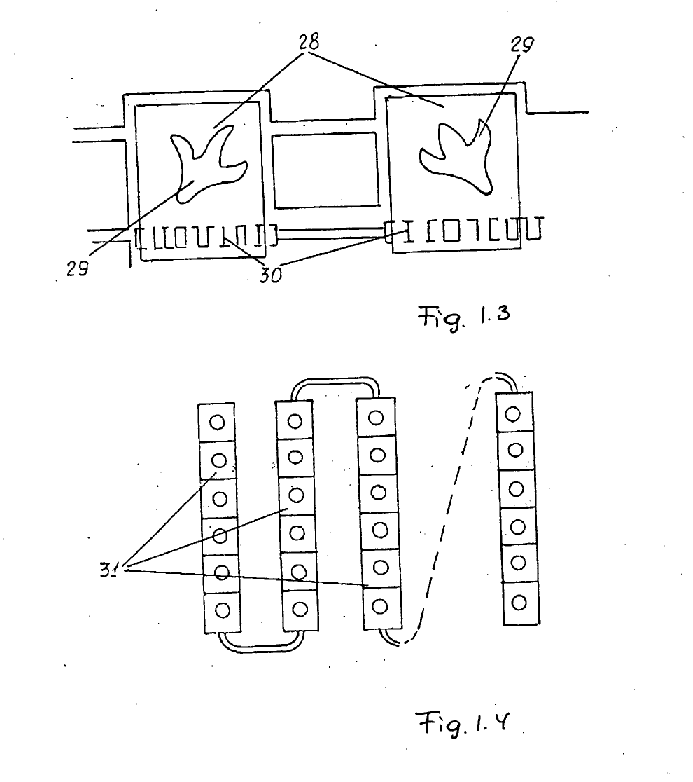

A device for dynamic illumination shown in FIG. 1 has groups of light sources 1 . . . m which are united by a power supply bus 2 and have a grounding bus 3. Each group of the light sources 1 . . . m is formed as a non-disassemblable module shown in FIG. 2 with a first input 4 connected with the power supply bus, and the second input 5 connected with the grounding bus 3.

The light emitting module shown in FIG. 2 has for example two light diodes 6 and 7, two ballast resistors 8 and 9 which correspond to the light diodes, electronic keys 10, 11, and a microprocessor 12 with outputs 13 and 14 connected with the input 15 and 16 of electronic keys 10, 11. All these elements are located in a non-disassemble casing 17. Programming of the processor is formed before its mounting in the non-disassembleable casing 17.

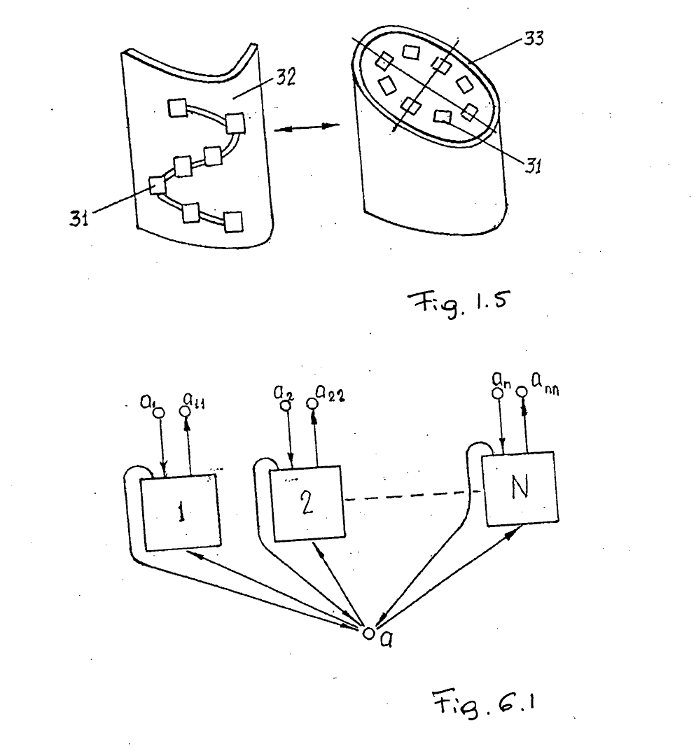

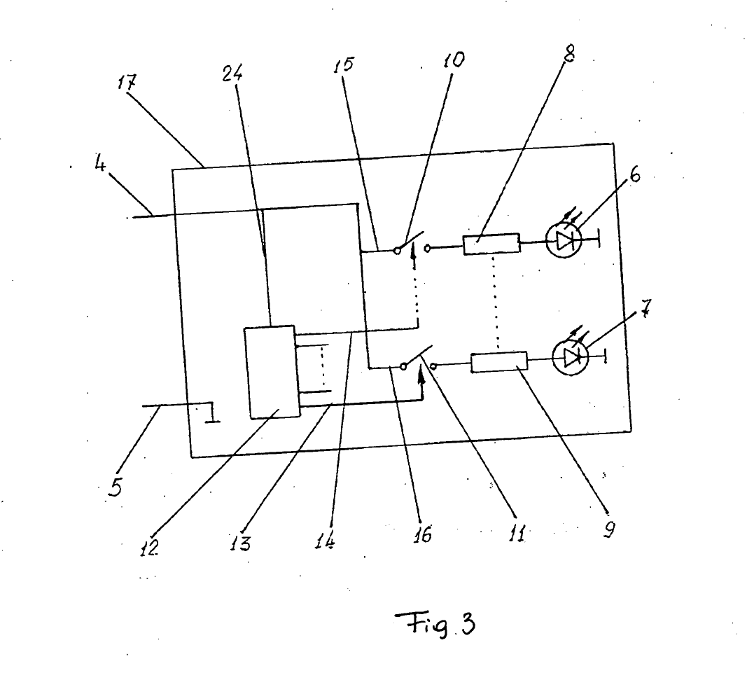

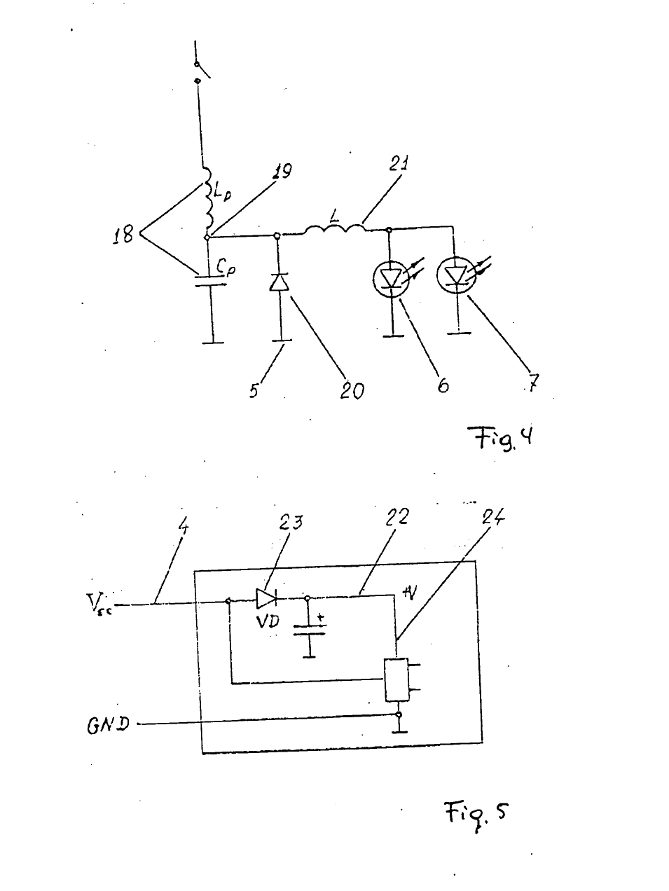

Each electronic key 10, 11 is loaded, as shown in FIG. 4, by a series LC contour 18 with a semi period of own oscillations which is equal to the time length of the pulse tᵢ (FIG. 3) of the frequency-pulse modulation. As shown in FIG. 3, tₙ=const, f=1/T, wherein f is constant, T=(0 . . . 255), tₙ. A medium point 19 of the LC contour 18 is connected through a reversely displaced diode 20 to the ground 5, and is connected through a throttle 21 with the light diodes 6 and 7.

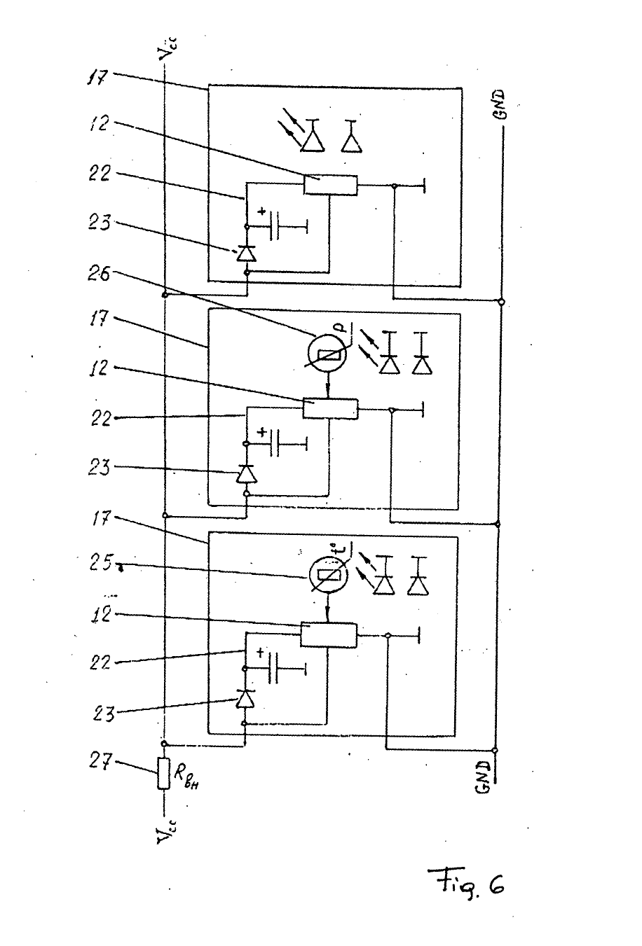

At least one module has an autonomous power source as shown in FIG. 5. The inner power supply bus 22 is connected with an exterior power supply bus 4 through the directly displaced diode 23 and universal input/output 24 of the processor 12.

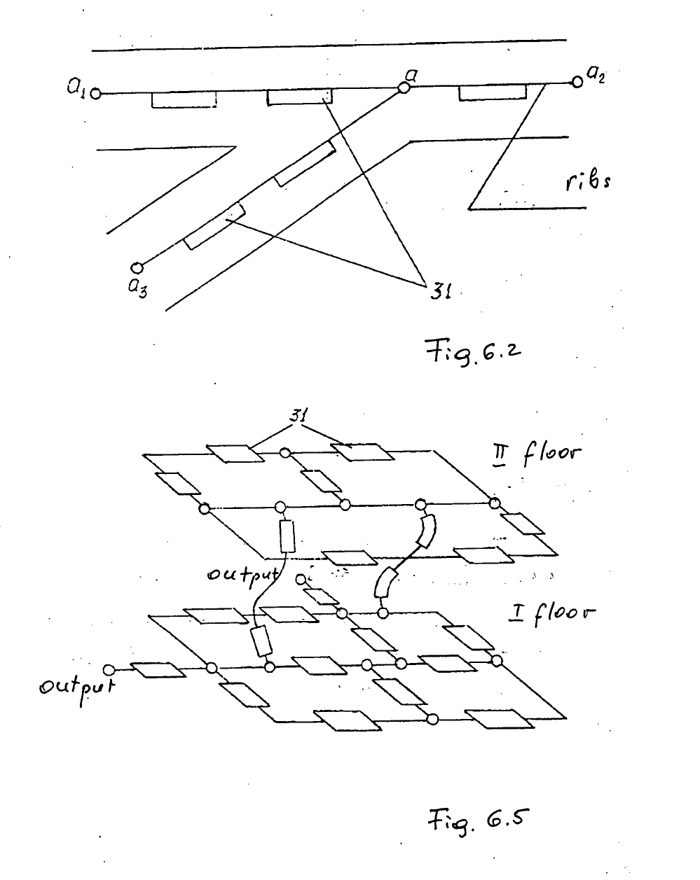

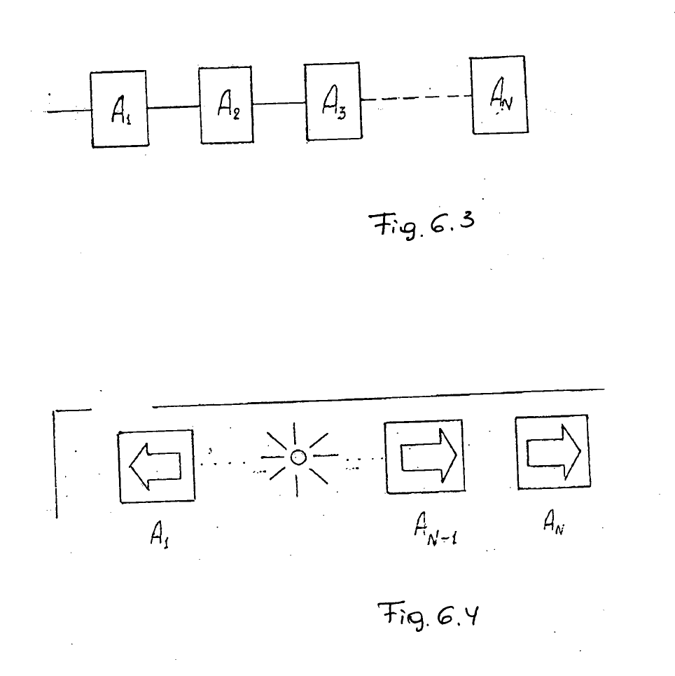

Sensors of exterior signals can be located, as shown in FIG. 6, wherein the connection of two modules is illustrated. They have a built-in temperature sensor 25 and a pressure sensor 26, as well as a resistor of inner resistance of the current source 27.

The operation of the device and its application are shown by means of several examples.

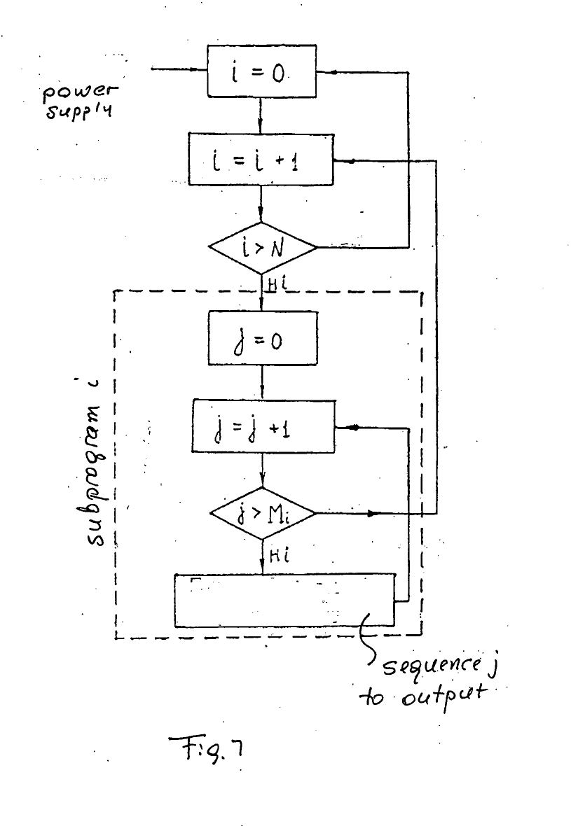

When voltage is supplied from an exterior direct power source to the exterior bus 4, a signal is supplied to the universal input/output 24 of the microprocessor 12, and it first turns the whole circuit into a waiting mode, and then it starts operating in accordance with the provided algorithm as shown in FIG. 7. In accordance with the operation of the program, control pulses (turning-on) pulses are supplied to the electronic keys 10, 11 in FIG. 2 from the outputs 13, 14 of the microprocessor 12. When the electronic key is turned on, the ballast resistor 8 (9) is connected to the exterior power bus 21, and a voltage pulse is supplied to the corresponding light diode 6, (7). The tunneling of the generated sequence of pulses corresponds to the required brightness of illumination of the light diode (FIG. 3). When an oscillation contour is used instead of the ballast resistor (FIG. 4), the electronic key is loaded with a series LC contour 18 with the semi period of own oscillations equal to the time length of the pulse tᵢ of the frequency-pulse modulation (FIG. 3), and the medium point 19 of the LC contour is connected through the reversely displaced diode 2 to the ground, and also through a throttle 21 with the light diode 6 or a group of the light diodes 6, 7. Therefore, the one semi-period resonance conversion of voltage is carried out.

When several modules, including those with the built-in sensors in FIGS. 1 and 6 are interacted with one another, the power source V_{CC} with a greater rᵢₙ inner resistance 27 is utilized. When it is necessary to exchange information between the modules, the leading module loads the external power supply bus 4 with its output. All modules in this moment are transferred to the autonomous power supply and monitor along the power supply bus the information presented in a successive code which is transmitted by the leading module in accordance with the predetermined protocol of exchange. After the transmission of data, the leading module releases the power supply bus, and any other module can perform the transmission of data along the power supply bus, or in other words to become a leading module. The subsequent operation of the modules depends on the individual condition of the module and the information transmitted through the bus.

Since the microprocessor is formed with the possibility of carrying out the sequence of actions which are necessary for turning on of the light sources and changing their intensity in accordance with the program which perform N subprograms of light effects, therefore after turning on of the power the program carries out zeroing of the i-th number of the subprogram of the light effects, which corresponds to the waiting mode. Then, starting from 1-st, successively i-th numbers of subprograms are introduced, and the fulfillment of the condition i<N is checked. After obtaining positive result of checking, the carrying out of i-th subprogram of light effects is performed. After completion of the carrying out of i-th subprogram of the light effects, the subprogram number is increased by one, the checking and fulfilling of the i+1 subprogram is repeated again. All actions are therefore repeated until the whole sequence of N subprograms is completed. Each subprogram forms Mi of digital words which provide L bytes of signal for controlling the light sources and corresponding to the number of light sources, pulses cycled by the pulse generator. The program provides outputting of the signals which control the light intensity and represent digital j-th sequence of 8-register numbers which correspond to the number of the light sources. The above described algorithm is shown in FIG. 7.

From the point of view of formal theory, the multi-processor system is a plurality of automatic elements (V. M. Glushkov. Introduction into Cybernetics, Kiev, AN USSR 1964, page 324). Each automatic element is characterized by two functions:

y=λ(a, x)—function of output;

a′,=δ(a, x)—function of transition;

wherein X={x} is a multiplicity of input language,

Y={y}—is a multiplicity of output language;

A={a} is a multiplicity of conditions;

“Words” x and y can be of an alternative length.

Each automatic element has input and output channels for supplying input and output signals correspondingly.

### EXAMPLE 1

### Light Diode Line

Each microprocessor operates in accordance with the cycle so as to provide change of brightness and color in a given concrete location in accordance with an individual program, and all of them provide a common light-dynamic effect.

One module can be represented as a unity of two automatic elements as shown in FIG. 1.1. One of them operates as a counter of conditions 0, 1, 2 . . . in response to the supplied synchro pulse (input signal I). The synchro pulse generates one of its modules, by supplying it to the electric bus.

Therefore the automatic element A1 operates in accordance with the cycle A1. Physically, it is simply one register with zeroing after reaching the condition with the maximum number. A number of its condition represents the output signal of the automatic element A1. This signal is an input signal for the automatic element A2. The automatic element A2 is more complicated. Each of its conditions corresponds to a predetermined condition of operation of the light sources of the given module, and occupies a greater part of the memory of the program. However, since the number of equivalent conditions is limited (conditions a1 and a2 are equivalent when y=a1, x1)=(a2, x2), and therefore they output the same outputting control signal to the light sources of the a module), therefore the automatic element A2 can be “processed” or in other words minimized so that a1=a2 and therefore it is possible to use more memory and obtain more different light effects.

A group of all automatic elements of the line A1, A2, A3 . . . An can be represented as shown in FIG. 1.2, wherein arrows indicate input and output channels of each automatic element, Aa, A1, A2 . . . an are points of connection of the channels, a point arrow is a channel of connection of a programmer connectable through a special connector with the electric bus and can change the program of each processor and therefore of the whole device, after which it is disconnected. Therefore, the device includes:

a light diode module with a microprocessor;

a program for each module;

a programmer;

a program which generates programs for each module depending on its location and the desired light-dynamic effect.

Such a circuit is very mobile and plastic, it provides the possibility of reprogramming of all microprocessors separately, and therefore of a whole line of the modules, it makes possible to change light-dynamic effects depending on the situation. Since the controlling program is distributed over the separate modules, therefore light-dynamic effects can be very rich.

When lines of different length are formed (different number of modules), they are different from one another only by linear sizes of structural elements which unite them and the electric bus, in contrast to known analogous devices, in which the change of the length of the line of light sources always leads to a change of the whole electrical circuit, even if it is not significant.

### EXAMPLE 2

### Illumination of Windows

For creating an original light-dynamic effect, conventional windows are utilized. For this purpose a light-dispersing image 29 is applied on one or several glasses 28, and a device for introduction of light into the glass is provided. Modular lines 30 of light sources are further provided. All lines are connected with one another by a single electrical bus shown in FIG. 1.3. Since all modules of each line on each window operate in accordance with coordinated programs, it is possible to create a single light-dynamic effect for all illuminated windows.

When the applied image is changed and applied on neighboring windows, new windows are supplied with additional lines of light sources, which are also connected to the electrical bus. Because of the change of the images and configuration of the system (additional windows) it is necessary to change the program of the light-dynamic effects. Then, all elements which are described in the Example 1 are maintained the same.

By means of a special program, programs for each microprocessor are generated with consideration of its coordinate and desired effect. Then these individual programs are introduced in each module through the programmer and the electric bus.

### EXAMPLE 3

### Two-Coordinate Illumination

The lines 31 of the light sources are assembled into two-coordinate screens shown in FIG. 1.4. Similarly to other cases where the line with a great number of light modules with light sources is utilized, the frequency modulation significantly reduces requirements to electronic circuits. By means of such a “screen”, any image applied to the light-dispersing surface can be illuminated from the front, or the image which is assembled from colored light-dispersing elements can be illuminated as well. The device is substantially analogous to the so-called light-boxes, in which between two matted surfaces with the applied images, an elongated (non-pointed) static light source is arranged. The screen based on the modular lines differs from the light boxes in that it allows to create dynamic two-dimensional light effects. Because of this and because of the advantages of the modular programming devices described herein above, a wide area is provided for designs in advertising and decorative art.

Moreover, it is possible to use such constructions as an information board. In such boards, the symbols can appear not only as turned-on or turned-off but they can appear and disappear smoothly as effects connected with the smooth change of brightness of pointed sources. Such effects can be aesthetically amplified when the board includes a light-dispersing screen. Moreover, the modular light lines in the information board can be located along a curved surface (a cylindrical board, a concave board, etc.).

### EXAMPLE 4

### Curved Line

In accordance with a special construction 32, the module 31 are located along a curved line and they illuminate the light-dispersing volume.

Flat, curved light-dispersing elements which are illuminated from the front can be utilized as shown in FIG. 1.5. Known curved neon lamps are analogous to this approach. The difference between the inventive device and the neon lamps is that first of all the illumination is performed not for a line having a constant thickness, but instead a flat figure, and secondly the illumination can be changed as to its brightness and coordinate, which provides significant advantage over the existing devices. The modular principle gives a designer the possibility of designing devices of any scale, without taking into consideration a control circuit for light elements of the device.

In another case, in the special construction 33, the module 31 are located along an arbitrary curve and illuminate light-dispersing elements as shown in FIG. 1.6. Since it is not necessary to provide a special control circuit for each specific case, it is possible to create any project with any algorithm for changing the brightness and color in time.

### EXAMPLE 5

### Line with Exchange of Data

In the case where modules are provided with additional sensors 25, 26 and different signals are supplied from the sensors, it is necessary to provide an exchange of data between various modules, and a group of automatic elements has a more complicated structure shown in FIG. 6.1. In the structure-a is a connecting point for exchange of information, aₙ is an input signal for the sensor, aₙₙ is an output signal of the sensor.

The system has N! cycles, where N is a number of elements. Therefore, there is a possibility of N! cycling. This problem can be overcome with the corrected realization of an algorithm of the exchange. The concrete realization depends on an objective to be reached and on topology of location of the elements.

The topology of location and a conducting connection between the modules which realize a concrete task when automatic elements with exchange of data are needed, depends on the task. In any case this topology is described by a connecting graph, where knots correspond to intersections of “corridors” and correspondingly conducting connection of the electric bus (through the bus can be carried out as a radio connection or ultrasound connection, and the modules can have independent autonomous power supply), which in turn is represented by a lines-ribs between them (a connection graph is a graph in which from every along the ribs it is possible to reach any other of the graph). The module-automatic elements are “fitted” on the ribs as shown in FIG. 6.2.

### EXAMPLE 6

### Linear Topology

The linear topology is demonstrated by a linear connecting graph shown in FIG. 6.3. The example of realization of the linear topography of location of the automatic elements is a fire-prevention safety system in a subway car or in a building which has only one corridor on one floor.

In the case of a fire and/or presence of smoke, the sensors register the event and all modules perform an exchange of data therebetween. As a result, each module generates a light information signal A1, A2 . . . An (arrow) which shows a direction of evacuation, and the intensity (brightness) of the signal and/or frequency of flickering represents a proximity to a source of danger, as shown in FIG. 6.4. The technical realization of this concept is the same as for the light-diode lines.

### EXAMPLE 7

### Arbitrary Topology

In a general case, tasks which are achieved with the use of modular light indicators can be complicated. A protective signalization or fire-protection signalization of a building or home can be an example of this. In the protective signalization the indicators use arrows and frequency of flickering to show a direction and a distance to an object which reached the protective territory in unauthorized manner. In this case, the graph which represents a corresponding topology does not have a single chain of modules, but instead includes a plurality, more than one, of intersecting (for example in a criss-cross fashion) chains, for example a multi-story building, as shown in FIG. 6.5.

Of course creation of an algorithm of data exchange between various automatic elements-modules, is not a trivial task. It is to be mentioned that further actions for writing of a program is a routine process which is easily to be automated, and a combination of the modules with relatively simple programs can realize a very complicated algorithm of behavior of the whole system.

As can be seen from the description of the above mentioned device, the algorithm of its operation and the examples of realization, it has broad functional possibilities, since it can be used with adaptation to various light carriers, including flat and curved surfaces as well as various volumes.

At the same time, it is easy to assemble modules to provide unlimited number of various light effects.

It will be understood that each of the elements described above, or two or more together, may also find a useful application in other types of constructions differing from the types described above.

While the invention has been illustrated and described as embodied in device for dynamic illumination, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for dynamic illumination, comprising groups of light sources; a power supply source, each of said groups of light sources is formed as a light-emitting module which includes light diodes selected from the group consisting of one light diode and several light diodes, electronic keys corresponding to said light diodes for power supply of said light diodes through ballast resistors, a processor containing control programs for controlling brightness and color of said light diodes in time with the use of a method of frequency-pulse modulation, for controlling said electronic keys and interaction of the processors including synchronization of their operation, said modules having inputs which are electrically connected with one another and outputs which are grounded, wherein said modules are united in three-dimensional structures.

2. A device as defined in claim 1; and further comprising an external power source for power supply of the device.

3. A device as defined in claim 1, wherein at least one of said modules has an independent power source.

4. A device as defined in claim 1, wherein at least one of said modules includes at least one signal sensor.

5. A device as defined in claim 4, wherein said at least one signal sensor is a sensor selected from the group consisting of a temperature sensor and a pressure sensor.

6. A device as defined in claim 1, wherein said processor is formed so that it performs a sequence of actions required for turning off of said light sources and changing of their intensity in accordance with a program realizing N subprograms of light effects, wherein after turning of the power source zeroing of i-th number of the subprogram of light effects is performed in corresponding with a waiting period, and then starting from 1-st subprogram successively i-numbers of subprograms are introduced, fulfilling of condition i<N is checked, and after a positive result of the checking i-th subprogram of light effects is performed, and after completing of the performance of i-th subprogram of light effects number is increased by one, checking and the performing of i+1th subprogram is repeated, and these actions are repeated at least the whole sequence N of subprograms is performed, wherein each subprogram forms Mi digital words which provide L bytes of control signal for said light sources and in correspondence with the number of said light sources, outputting of signals controlling the light intensity, and representing a digital j-th sequence of 8-register numbers which correspond to the number of said light sources.
